(19) United States
(12) Patent Application Publication
(10) Pub. No.: US 2026/0292854 A1
(43) Pub. Date: Sep. 24, 2026

(54) POWER ALLOCATION FOR PHYSICAL SIDELINK FEEDBACK CHANNEL TRANSMISSIONS

(71) Applicant: QUALCOMM Incorporated, San Diego, CA (US)

(72) Inventors: Luanxia YANG, Beijing (CN); Chih-Hao LIU, San Diego, CA (US); Changlong XU, Beijing (CN); Shaozhen GUO, Beijing (CN); Siyi CHEN, Beijing (CN); Xiaoxia ZHANG, San Diego, CA (US); Jing SUN, San Diego, CA (US); Hao XU, Beijing (CN)

(21) Appl. No.: 19/473,312

(22) PCT Filed: May 17, 2023
(86) PCT No.: PCT/CN2023/094708

§ 371 Date: Oct. 7, 2025

(51) Int. Cl. H04W 72/25; H04W 52/32

(52) U.S. Cl. CPC H04W 72/25; H04W 52/32

(57) ABSTRACT

Various aspects of the present disclosure generally relate to wireless communication. In some aspects, a first user equipment (UE) may identify a plurality of physical sidelink feedback channel (PSFCH) transmissions to be simultaneously transmitted within a bandwidth associated with multiple dedicated physical resource blocks (PRBs). The first UE may allocate a transmission power to a PSFCH transmission of the plurality of PSFCH transmissions based at least in part on a power allocation rule, wherein the transmission power allocated to the PSFCH transmission is associated with a defined PRB, of the multiple dedicated PRBs, within the bandwidth. The first UE may transmit, to a second UE, the PSFCH transmission based at least in part on the transmission power. Numerous other aspects are described.

### FIELD OF THE DISCLOSURE

Aspects of the present disclosure generally relate to wireless communication and to techniques and apparatuses for power allocation for physical sidelink feedback channel (PSFCH) transmissions.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a first user equipment (UE) includes one or more memories; and one or more processors, coupled to the one or more memories, which, individually or in any combination, are operable to cause the apparatus to: identify a plurality of physical sidelink feedback channel (PSFCH) transmissions to be simultaneously transmitted within a bandwidth associated with multiple dedicated physical resource blocks (PRBs); allocate a transmission power to a PSFCH transmission of the plurality of PSFCH transmissions based at least in part on a power allocation rule, wherein the transmission power allocated to the PSFCH transmission is associated with a defined PRB, of the multiple dedicated PRBs, within the bandwidth; and transmit, to a second UE, the PSFCH transmission based at least in part on the transmission power.

In some implementations, a method of wireless communication performed by a first UE includes identifying a plurality of PSFCH transmissions to be simultaneously transmitted within a bandwidth associated with multiple dedicated PRBs; allocating a transmission power to a PSFCH transmission of the plurality of PSFCH transmissions based at least in part on a power allocation rule, wherein the transmission power allocated to the PSFCH transmission is associated with a defined PRB, of the multiple dedicated PRBs, within the bandwidth; and transmitting, to a second UE, the PSFCH transmission based at least in part on the transmission power.

In some implementations, a non-transitory computer-readable medium storing a set of instructions for wireless communication includes one or more instructions that, when executed by one or more processors of a first UE, cause the first UE to: identify a plurality of PSFCH transmissions to be simultaneously transmitted within a bandwidth associated with multiple dedicated PRBs; allocate a transmission power to a PSFCH transmission of the plurality of PSFCH transmissions based at least in part on a power allocation rule, wherein the transmission power allocated to the PSFCH transmission is associated with a defined PRB, of the multiple dedicated PRBs, within the bandwidth; and transmit, to a second UE, the PSFCH transmission based at least in part on the transmission power.

In some implementations, a first apparatus for wireless communication includes means for identifying a plurality of PSFCH transmissions to be simultaneously transmitted within a bandwidth associated with multiple dedicated PRBs; means for allocating a transmission power to a PSFCH transmission of the plurality of PSFCH transmissions based at least in part on a power allocation rule, wherein the transmission power allocated to the PSFCH transmission is associated with a defined PRB, of the multiple dedicated PRBs, within the bandwidth; and means for transmitting, to a second apparatus, the PSFCH transmission based at least in part on the transmission power.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of simultaneous physical sidelink feedback channel (PSFCH) transmissions, in accordance with the present disclosure.

FIGS. 5-6 are diagrams illustrating examples associated with power allocation for PSFCH transmissions, in accordance with the present disclosure.

FIG. 7 is a diagram illustrating an example process associated with power allocation for PSFCH transmissions, in accordance with the present disclosure.

FIG. 8 is a diagram of an example apparatus for wireless communication, in accordance with the present disclosure.

### DETAILED DESCRIPTION

A physical resource block (PRB) of a common interlace and a dedicated PRB may be located within a same bandwidth (e.g., a 1 MHz bandwidth). A user equipment (UE) may only transmit on the dedicated PRB, which may be based at least in part on a power spectral density (PSD) limit. However, the UE may possibly transmit more than one physical sidelink feedback channel (PSFCH) transmission simultaneously, and multiple dedicated PRBs may be located within the same 1 MHz bandwidth. In other words, the UE may transmit multiple simultaneous PSFCH transmissions, and the multiple dedicated PRBs may be located within the same 1 MHz bandwidth. In this case, the UE may not be configured to handle the PSD limit for the multiple simultaneous PSFCH transmissions and the multiple dedicated PRBs located within the same 1 MHz bandwidth. Further, the UE may not be configured to allocate a transmission power among the multiple simultaneous PSFCH transmissions. As a result, the UE may not be able to handle the multiple simultaneous PSFCH transmissions when the multiple dedicated PRBs are located within the same 1 MHz bandwidth, which may degrade an overall performance of the UE.

Various aspects relate generally to a power allocation for PSFCH transmissions. Some aspects more specifically relate to a power allocation for PSFCH transmissions in sidelink unlicensed (SL-U) based at least in part on a power allocation among multiple simultaneous PSFCH transmissions, and based at least in part on prioritizations for the multiple simultaneous PSFCH transmissions while considering a PSD limit. In some examples, in a power control enhancement for a PSFCH in the SL-U, a first UE may identify a plurality of PSFCH transmissions to be simultaneously transmitted within a bandwidth (e.g., a 1 MHz bandwidth) associated with multiple dedicated PRBs. In some examples, the first UE may allocate a transmission power to a PSFCH transmission of the plurality of PSFCH transmissions based at least in part on a power allocation rule. In some examples, the transmission power allocated to the PSFCH transmission may be associated with a defined PRB, of the multiple dedicated PRBs, within the bandwidth. In some examples, the first UE may prioritize the plurality of PSFCH transmissions to be simultaneously transmitted based at least in part on a PSD limit. In some examples, the first UE may transmit, to a second UE, the PSFCH transmission based at least in part on the transmission power.

Particular aspects of the subject matter described in this disclosure can be implemented to realize one or more of the following potential advantages. In some examples, when the first UE is configured to transmit more than one PSFCH transmission simultaneously, and when the multiple dedicated PRBs are located within the bandwidth (e.g., the same 1 MHz bandwidth), the described techniques can be used by the first UE to allocate transmission power among multiple PSFCHs and to handle the PSD limit. As a result, based at least in part on the power control enhancement for the PSFCH in the SL-U, the first UE may be able to appropriately allocate the transmission power and handle the PSD limit when the multiple simultaneous PSFCH transmissions are present, thereby improving an overall performance of the first UE.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

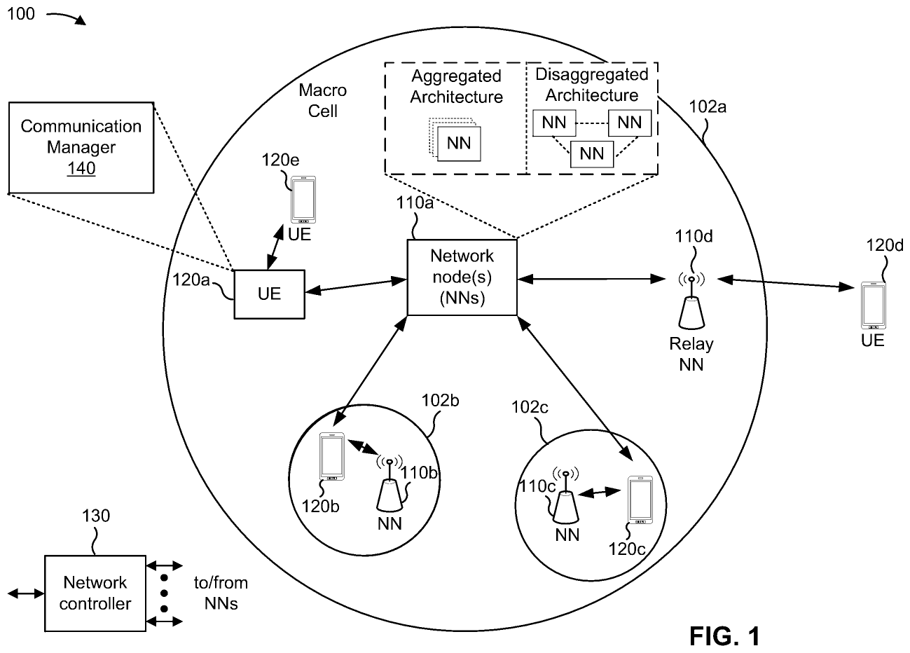

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first UE (e.g., UE 120a) may include a communication manager 140. As described in more detail elsewhere herein, the communication manager 140 may identify a plurality of PSFCH transmissions to be simultaneously transmitted within a bandwidth associated with multiple dedicated PRBs; allocate a transmission power to a PSFCH transmission of the plurality of PSFCH transmissions based at least in part on a power allocation rule, wherein the transmission power allocated to the PSFCH transmission is associated with a defined PRB, of the multiple dedicated PRBs, within the bandwidth; and transmit, to a second UE, the PSFCH transmission based at least in part on the transmission power. Additionally, or alternatively, the communication manager 140 may perform one or more other operations described herein.

As indicated above, FIG. 1 is provided as an example. Other examples may differ from what is described with regard to FIG. 1.

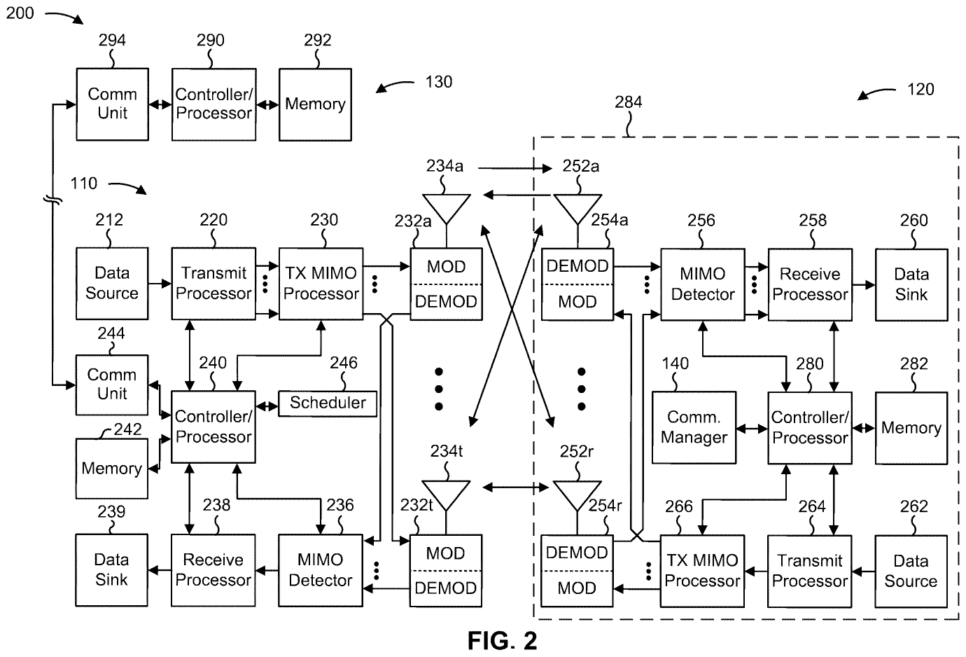

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

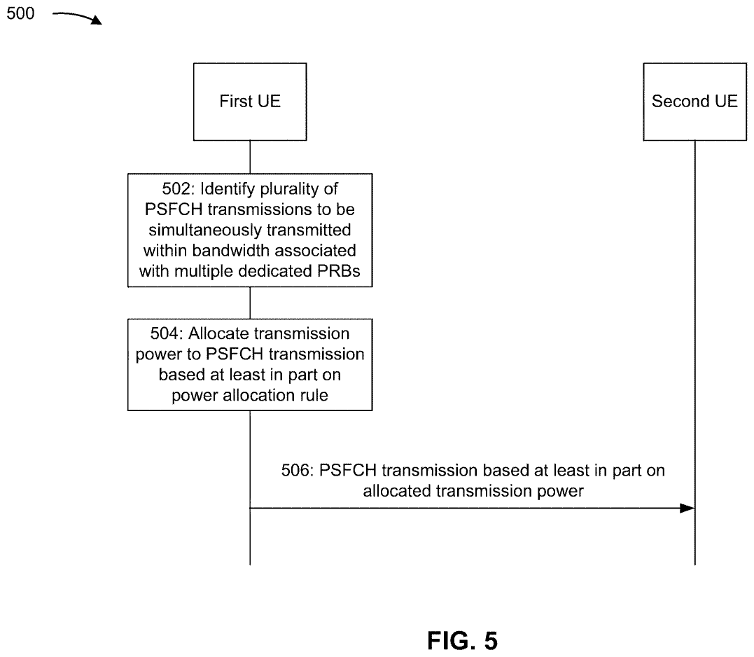

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-8).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-8).

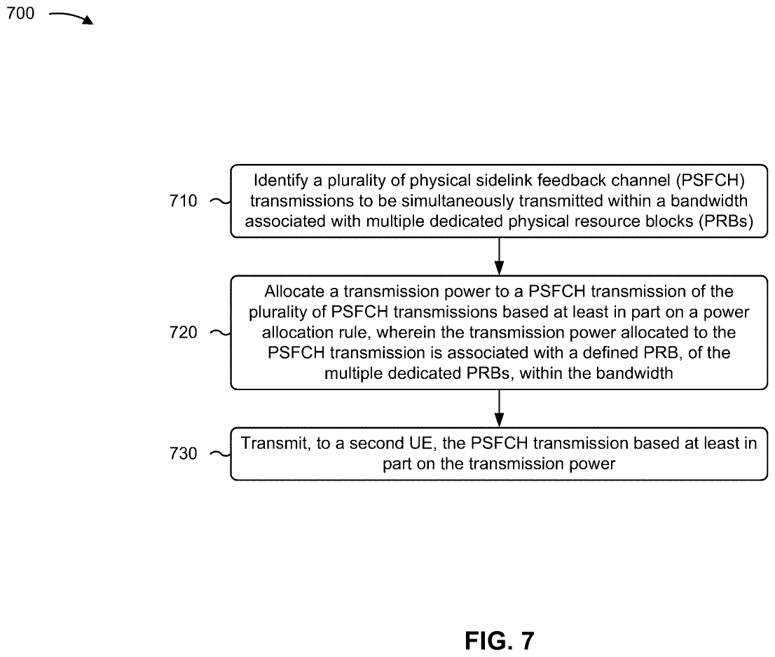

The controller/processor 240 of the network node 110, the controller/processor 280 of the UE 120, and/or any other component(s) of FIG. 2 may perform one or more techniques associated with power allocation for PSFCH transmissions, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, and/or other processes as described herein. In some examples, executing instructions may include running the instructions, converting the instructions, compiling the instructions, and/or interpreting the instructions, among other examples.

In some aspects, a first UE (e.g., UE 120a) includes means for identifying a plurality of PSFCH transmissions to be simultaneously transmitted within a bandwidth associated with multiple dedicated PRBs; means for allocating a transmission power to a PSFCH transmission of the plurality of PSFCH transmissions based at least in part on a power allocation rule, wherein the transmission power allocated to the PSFCH transmission is associated with a defined PRB, of the multiple dedicated PRBs, within the bandwidth; and/or means for transmitting, to a second UE, the PSFCH transmission based at least in part on the transmission power. The means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

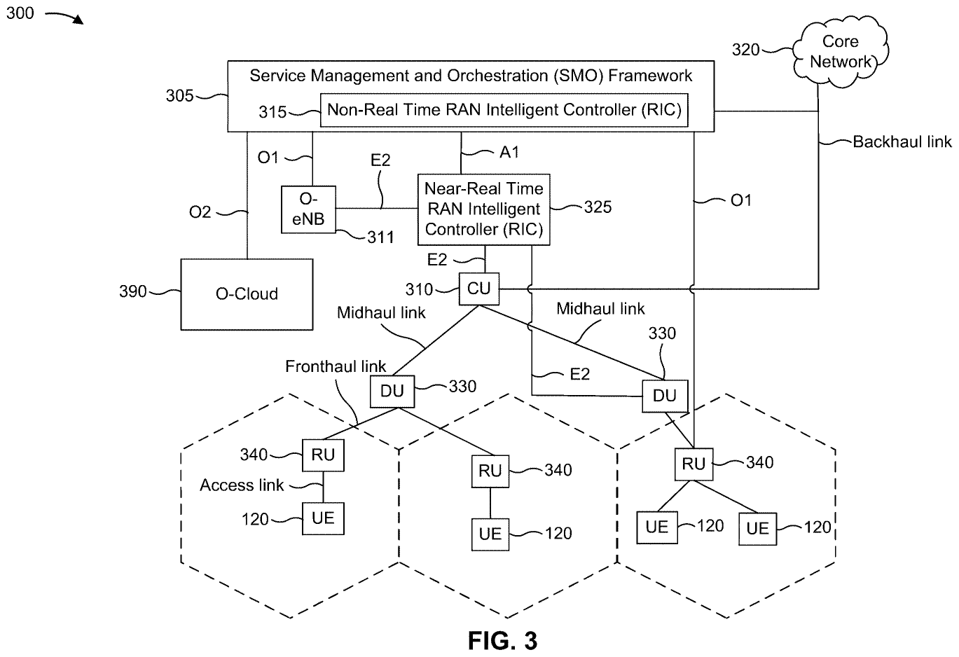

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

When a downlink pathloss based power control for PSFCH (dl-P0-PSFCH) parameter is provided to a UE, a required transmission (Tx) power ( [symbol] _{,one}) for the UE to transmit a PSFCH may be calculated based at least in part on: [symbol] _{,one}= [symbol] _{O}, +10 à\acute{ε}Ω₁₀(2)+| [symbol] [symbol] [dBm], where [symbol] , is a value of dl-P0-PSFCH,| is an alpha value for downlink pathloss based power control for PSFCH when dl-P0-PSFCH is configured (dl-Alpha-PSFCH) (when provided, or else |=1), and a pathloss [symbol] [symbol] = [symbol] [symbol] ,(\acute{η}) when an active sidelink bandwidth part (BWP) is on a serving cell [symbol] . A reference signal resource may be the one the UE uses to determine a power of a physical uplink shared channel (PUSCH) transmission scheduled by a downlink control information (DCI) format 0_0 in serving cell [symbol] , when the UE is configured to monitor a physical downlink control channel (PDCCH) for detection of the DCI format 0_0 in serving cell [symbol] . The reference signal resource may be the one corresponding to a synchronization signal (SS) and physical broadcast channel (PBCH) block used by the UE to obtain a master information block (MIB), when the UE is not configured to monitor the PDCCH for detection of the DCI format 0_0 in serving cell [symbol] .

When the UE supports up to [symbol] _{max,PSFCH} simultaneous PSFCH transmissions in a PSFCH transmission occasion, and when the UE has [symbol] _{sch,Tx,PSFCH} PSFCHs to be transmitted in a given PSFCH transmission occasion, the UE may select [symbol] _{Tx,PSFCH} PSFCHs for actual transmission with an ascending order of corresponding priority field values in a PSFCH transmission occasion. The UE may select [symbol] _{Tx,PSFCH} PSFCHs for actual transmission with the ascending order of corresponding priority field values in the PSFCH transmission occasion.

When [symbol] , and dl-P0-PSFCH is configured, and when a total transmission power of [symbol] _{sch,Tx,PSFCH} PSFCHs is equal to or less than [symbol] (e.g., [symbol] ,+10à\acute{ε}Ω₁₀ [symbol] _{sch,Tx,PSFCH}≤ [symbol] ), then [symbol] _{Tx,PSFCH}= [symbol] _{sch,Tx,PSFCH} and [symbol] _{PSFCH}, (Ω)= [symbol] _{PSFCH}, [dBm]). Here, [symbol] may indicate a maximum UE transmission power.

Otherwise, the UE may autonomously determine [symbol] _{Tx,PSFCH} PSFCH transmissions, first with an ascending order of corresponding priority field values over the PSFCH transmissions with hybrid automatic repeat request acknowledgement (HARQ-ACK) information, if any, and then with an ascending order of priority field values over the PSFCH transmissions with conflict information, if any. In this case, [symbol] _{Tx,PSFCH}≥max (1, Σ₌₁ [symbol] ), where [symbol] , for 1≤Ω≤8, is a number of PSFCHs with priority value Ω for PSFCH with HARQ-ACK information and [symbol] , for Ω>8, is a number of PSFCHs with priority value Ω 8 for PSFCH with conflict information. Further, [symbol] may be defined as a largest value satisfying [symbol] ,+10à\acute{ε}″Ω₁₀(max (1, Σ₌₁ [symbol] ))≤ [symbol] , where [symbol] is determined for transmission of all PSFCHs in Σ₌₁ [symbol] , if any, or [symbol] may be defined as zero otherwise.

Further, a PSFCH transmit power may be represented by: [symbol] _{PSFCH}, (Ω)=\acute{α}Ω\grave{ε} [symbol] 10 á\grave{ε}₁₀( [symbol] _{Tx,PSFCH}), [symbol] , [dBm], where [symbol] 10á\grave{ε}Ω₁₀( [symbol] _{Tx,PSFCH}) is associated with an allowed transmission power, and [symbol] , is associated with a required transmission power.

When [symbol] ,> [symbol] , and dl-P0-PSFCH is configured, the UE may first select [symbol] , PSFCHs in an ascending order of corresponding priority field values over the PSFCH transmissions with HARQ-ACK information, if any, and then with an ascending order of priority value over the PSFCH transmissions with conflict information. When the total transmission power of [symbol] _{max,PSFCH} PSFCHs is equal to or less than [symbol] (e.g., [symbol] , +10à\grave{ε}Ω₁₀ [symbol] _{max,PSFCH}≤ [symbol] ), then [symbol] _{Tx,PSFCH}= [symbol] _{max,PSFCH} and [symbol] _{PSFCH}, (Ω)= [symbol] _{PSFCH}, [dBm].

Otherwise, the UE may autonomously select [symbol] _{Tx,PSFCH} PSFCH transmissions in an ascending order of corresponding priority field values over the PSFCH transmissions with HARQ-ACK information, if any, and then with an ascending order of priority field values over the PSFCH transmissions with conflict information, if any. In this case, [symbol] _{Tx,PSFCH}≥max (1, Σ₌₁ [symbol] ), where [symbol] , 1≤Ω≤8, is a number of PSFCHs with priority value Ω for PSFCH with HARQ-ACK information and [symbol] , Ω>8, is a number of PSFCHs with priority value Ω 8 for PSFCH with conflict information. Further, [symbol] may be defined as a largest value satisfying [symbol] , +10á\grave{ε}Ω₁₀(max (1, Σ₌₁ [symbol] ))≤ [symbol] , where [symbol] is determined for transmission of all PSFCHs in Σ₌₁ [symbol] , if any, or [symbol] may be defined as zero otherwise.

Regarding a PSFCH transmission with a 15 kilohertz (kHz) subcarrier spacing (SCS) or a 30 kHz SCS, each PSFCH transmission may occupy one common interlace and K3 dedicated PRBs, where K3 is a configured value. On the K3 dedicated PRB(s), multiple cyclic shift (CS) pairs may be used, as in a legacy NR sidelink (SL) PSFCH transmission. When a PRB of a common interlace and a dedicated PRB are located within the same 1 MHz bandwidth, the UE may only transmit on the dedicated PRB, which may have an impact on meeting an occupied channel bandwidth (OCB) requirement. Regarding the PSFCH transmission with the 15 kHz SCS or the 30 kHz SCS, each PSFCH transmission may occupy one dedicated interlace. Regarding the PSFCH transmission with the 15 kHz SCS or the 30 kHz SCS, each PSFCH transmission may occupy K4 dedicated PRB(s) and K2 common PRBs (e.g., K2=2, and K4 may be configured), where the K2 common PRBs may be located at the two edges of a resource block set. When each PSFCH transmission occupies the K4 dedicated PRB(s) and the K2 common PRBs, a PSD limitation may be satisfied. Further, some restrictions may be introduced on the locations of the K4 dedicated PRB(s) and/or the K2 common PRBs (e.g., whether the K4 dedicated PRB(s) and/or the K2 common PRBs are on the same interlace).

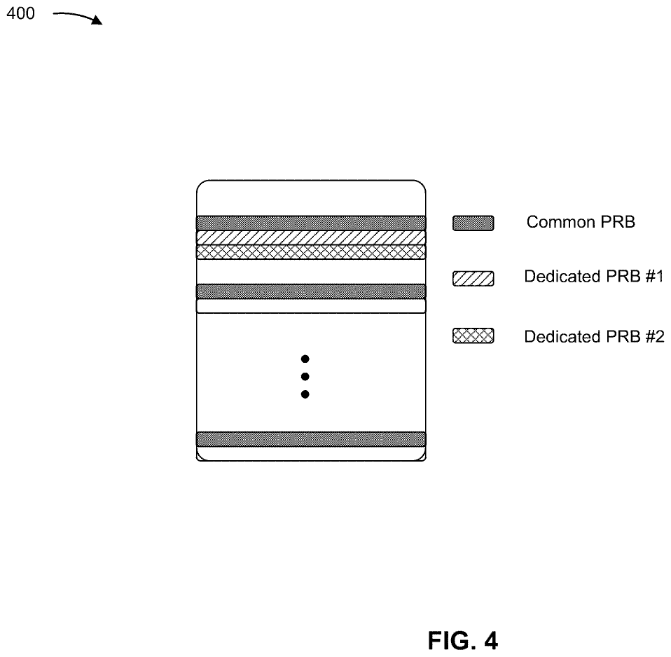

FIG. 4 is a diagram illustrating an example 400 of simultaneous PSFCH transmissions, in accordance with the present disclosure.

As shown in FIG. 4, when a PRB of a common interlace and a dedicated PRB are located within a same 1 MHz bandwidth, a UE may only transmit on the dedicated PRB, which may be based at least in part on a PSD limit. However, the UE may possibly transmit more than one PSFCH transmission simultaneously, and multiple dedicated PRBs may be located within the same 1 MHz bandwidth. In other words, the UE may transmit multiple simultaneous PSFCH transmissions, and the multiple dedicated PRBs may be located within the same 1 MHz bandwidth. In this case, the UE may not be configured to handle the PSD limit for the multiple simultaneous PSFCH transmissions and the multiple dedicated PRBs located within the same 1 MHz bandwidth. Further, the UE may not be configured to allocate a transmission power among the multiple simultaneous PSFCH transmissions. As a result, the UE may not be able to handle the multiple simultaneous PSFCH transmissions when the multiple dedicated PRBs are located within the same 1 MHz bandwidth, which may degrade an overall performance of the UE.

As indicated above, FIG. 4 is provided as an example. Other examples may differ from what is described with regard to FIG. 4.

In various aspects of techniques and apparatuses described herein, in a power control enhancement for a PSFCH in an SL-U, a first UE may identify a plurality of PSFCH transmissions to be simultaneously transmitted within a bandwidth (e.g., a 1 MHz bandwidth) associated with multiple dedicated PRBs. The first UE may allocate a transmission power to a PSFCH transmission of the plurality of PSFCH transmissions based at least in part on a power allocation rule. The transmission power allocated to the PSFCH transmission may be associated with a defined PRB, of the multiple dedicated PRBs, within the bandwidth. The first UE may prioritize the plurality of PSFCH transmissions to be simultaneously transmitted based at least in part on a PSD limit. The first UE may transmit, to a second UE, the PSFCH transmission based at least in part on the transmission power. In some aspects, when the first UE is configured to transmit more than one PSFCH transmission simultaneously, and when the multiple dedicated PRBs are located within the bandwidth (e.g., the same 1 MHz bandwidth), the first UE may allocate transmission power among multiple PSFCHs and the UE may handle the PSD limit. As a result, based at least in part on the power control enhancement for the PSFCH in the SL-U, the first UE may be able to appropriately allocate the transmission power and handle the PSD limit, thereby improving an overall performance of the first UE.

FIG. 5 is a diagram illustrating an example 500 associated with power allocation for PSFCH transmissions, in accordance with the present disclosure. As shown in FIG. 5, example 500 includes communication between a first UE (e.g., UE 120a) and a second UE (e.g., UE 120e). In some aspects, the first UE and the second UE may be included in a wireless network, such as wireless network 100. The first UE and the second UE may be associated with an SL-U.

As shown by reference number 502, the first UE may identify a plurality of PSFCH transmissions to be simultaneously transmitted within a bandwidth associated with multiple dedicated PRBs. The plurality of PSFCH transmissions may overlap with each other in a time domain. The bandwidth may be associated with one megahertz (MHz). The bandwidth may be associated with a common PRB and the multiple dedicated PRBs.

As shown by reference number 504, the first UE may allocate a transmission power to a PSFCH transmission of the plurality of PSFCH transmissions based at least in part on a power allocation rule. The transmission power allocated to the PSFCH transmission may be associated with a defined PRB, of the multiple dedicated PRBs, within the bandwidth.

In some aspects, the power allocation rule is based at least in part on: a maximum UE transmitted power associated with a plurality of PSFCH transmissions assigned with a priority ( [symbol] ), a minimum power allocated from a common PRB to satisfy an OCB requirement ( [symbol] ,), a quantity of common PRBs ( [symbol] ,), a quantity of transmitted PSFCHs ( [symbol] ₓ,), a maximum allowed transmitted power within the bandwidth ( [symbol] ), a quantity of PRBs used by one PSFCH within the bandwidth ( [symbol] ,1), and/or a quantity of actual transmitted PSFCHs within the bandwidth ( [symbol] _{x,1}).

In some aspects, the power allocation rule for PSFCH may be defined. The first UE may first select PSFCH transmissions based at least in part on a legacy rule, and then the first UE may allocate power for each PSFCH transmission accordingly. When the first UE transmits more than one PSFCH transmission within the same 1 MHz, the first UE may determine a PSFCH transmission power at an Ωth PRB ( [symbol] ,) within the same 1 MHz as: [symbol] =min [symbol] [symbol] , 10 log₁₀ [symbol] , 0 log₁₀ [symbol] ,· [symbol] ₃, [symbol] 10 log₁₀ [symbol] ,1· [symbol] , 1, where [symbol] is determined for transmission of all PSFCHs assigned with a priority, [symbol] , is the minimum power allocated from common PRBs to meet the OCB requirement, [symbol] , is the quantity of common PRBs, [symbol] ₓ, is the quantity of transmitted PSFCHs, [symbol] is the maximum allowed transmitted power within the 1 MHz, [symbol] ,1 is the quantity of PRBs which are used by one PSFCH within the same 1 MHz, and [symbol] ₓ, 1 is the quantity of actual transmitted PSFCHs within the same 1 MHz.

In some aspects, the first UE may prioritize the plurality of PSFCH transmissions to be simultaneously transmitted based at least in part on a PSD limit. A maximum quantity of simultaneous PSFCH transmissions ( [symbol] ,) may be supported in a PSFCH transmission occasion. A quantity of scheduled PSFCH transmissions ( [symbol] ,) may be available to be transmitted in the PSFCH transmission occasion. The first UE may select a quantity of PSFCHs ( [symbol] ,) for actual transmission, from the quantity of scheduled PSFCH transmissions, and the first UE may subsequently apply a rule to satisfy the PSD limit.

In some aspects, a prioritization for simultaneous PSFCH transmissions may be based at least in part on the PSD limit. When the first UE supports up to [symbol] , simultaneous PSFCH transmissions in the PSFCH transmission occasion, and the first UE has [symbol] , PSFCHs to be transmitted in a given PSFCH transmission occasion, the first UE may select [symbol] ,PSFCHs for actual transmission. In some aspects, the first UE may first select the [symbol] , PSFCHs based at least in part on a legacy rule, and then the first UE may consider the PSD limit.

In some aspects, the multiple dedicated PRBs may be allocated for multiple PSFCHs within the bandwidth. The first UE may transmit a PSFCH, of the plurality of PSFCH transmissions, associated with a highest priority among the plurality of PSFCH transmissions having the multiple dedicated PRBs located within the bandwidth, based at least in part on the rule to satisfy the PSD limit. In some aspects, the first UE may select the PSFCH, based at least in part on the PSFCH being associated with an earliest slot, among multiple PSFCHs being located within the bandwidth and having a same priority. In some aspects, an upper bound may be associated with the quantity of PSFCH transmissions, and the quantity of PSFCH transmissions may be within the bandwidth, based at least in part on the rule to satisfy the PSD limit. In some aspects, the first UE may determine PSFCH transmissions with an ascending order of corresponding priority field values over PSFCH transmissions with HARQ-ACK information, and with an ascending order of corresponding priority field values over PSFCH transmissions with conflict information, and a quantity of actual transmitted PSFCHs within the bandwidth ( [symbol] ,1) may be based at least in part on a minimum required transmitted power per PRB for PSFCH transmission ( [symbol] ,).

In some aspects, to satisfy the PSD limit, when the first UE transmits PSFCH transmissions simultaneously, and when multiple dedicated PRBs allocated for multiple PSFCHs are within the same 1 MHz, the first UE may only transmit the PSFCH with the highest priority among PSFCHs whose dedicated PRBs are located within the same 1 MHz. The first UE may select the PSFCH associated with the earliest slot when multiple PSFCHs located within the same 1 MHz have the same priority. In some aspects, to satisfy the PSD limit, the upper bound may be introduced for a transmitted PSFCH within the same 1 MHz. The first UE may autonomously determine PSFCH transmissions first with the ascending order of corresponding priority field values over the PSFCH transmissions with HARQ-ACK information, if any, and then with the ascending order of priority value over the PSFCH transmissions with conflict information, if any.

In this case,

$$, 1 = 10 \text{?}$$

$$\text{?} \text{indicates text missing or illegible when filed}$$

within the same 1 MHz, where [symbol] , is the minimum required transmitted power per PRB for PSFCH transmission.

In some aspects, the first UE may compare an actual PSFCH transmit power with the PSD limit, based at least in part on the rule to satisfy the PSD limit. The actual PSFCH transmit power may be per one PRB per PSFCH, and a defined quantity of transmitted PSFCHs within the bandwidth may be based at least in part on the actual PSFCH transmit power. In some aspects, the first UE may determine PSFCH transmissions with an ascending order of corresponding priority field values over PSFCH transmissions with HARQ-ACK information, and with an ascending order of corresponding priority field values over PSFCH transmissions with conflict information.

In some aspects, to satisfy the PSD limit, the actual PSFCH transmitted power may be compared with the PSD limit. The actual transmitted power per one PRB per PSFCH may be represented by: [symbol] _{PSFCH}, (Ω)= [symbol] _{PSFCH}, (Ω) 10 log₁₀( [symbol] ₃), where [symbol] _{PSFCH}, (Ω) is the value which may be determined by following a legacy rule. The allowed number of transmitted PSFCHs within the same 1 MHz may be represented by: [symbol] ,

$$1 , = 10 \text{?} .$$

$$\text{?} \text{indicates text missing or illegible when filed}$$

In some aspects, the first UE may autonomously determine PSFCH transmissions first with the ascending order of corresponding priority field values over the PSFCH transmissions with HARQ-ACK information, if any, and then with the ascending order of priority value over the PSFCH transmissions with conflict information, if any. In this case, [symbol] , 1≤ [symbol] ,1, within the same 1 MHz.

In some aspects, the first UE may apply a rule based at least in part on the PSD limit, and the first UE may subsequently select a quantity of PSFCHs for actual transmission, from the quantity of scheduled PSFCH transmissions. In some aspects, the first UE may first consider the PSD limit, and then the first UE may select [symbol] , PSFCHs based at least in part on a legacy rule. The first UE may select the PSFCH based at least in part on the PSD limit. When the first UE transmits PSFCH transmissions simultaneously, and when multiple dedicated PRBs allocated for multiple PSFCHs are within the same 1 MHz, the first UE may only transmit the PSFCH with a highest priority among PSFCHs whose dedicated PRBs are located within the same 1 MHz. Further, an upper bound may be introduced for a transmitted PSFCH within the same 1 MHz.

As shown by reference number 506, the first UE may transmit, to a second UE, the PSFCH transmission based at least in part on the transmission power, where the transmission power may be based at least in part on the power allocation rule. The PSFCH transmission may be one of the multiple PSFCH transmissions that are simultaneously transmitted to the second UE.

As indicated above, FIG. 5 is provided as an example. Other examples may differ from what is described with regard to FIG. 5.

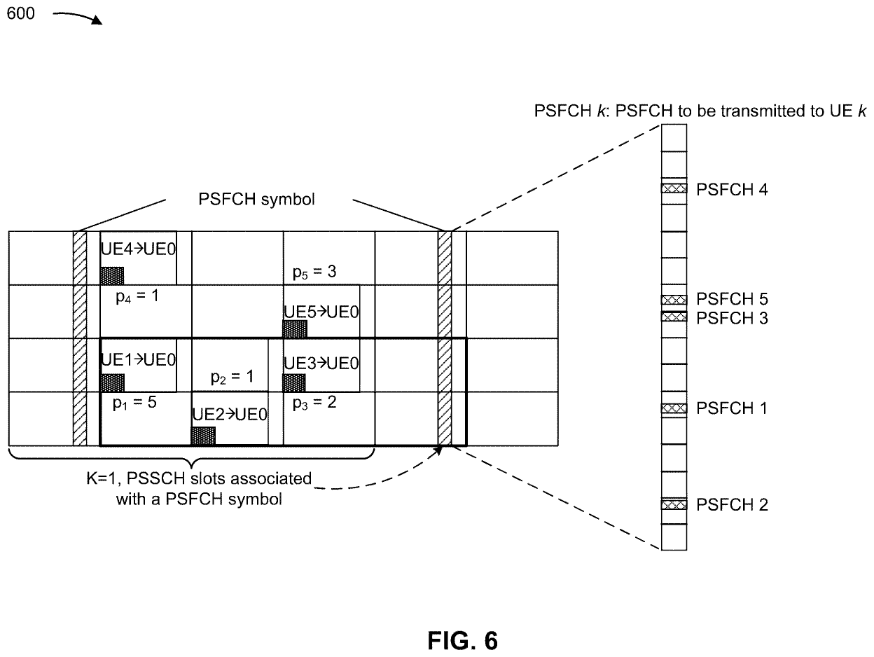

FIG. 6 is a diagram illustrating an example 600 associated with power allocation for PSFCH transmissions, in accordance with the present disclosure.

As shown in FIG. 6, a UE may transmit multiple simultaneous PSFCHs to UE k in a PSFCH symbol. The PSFCH symbol may be associated with physical sidelink shared channel (PSSCH) slots. In this example, the UE may have five PSFCHs to be transmitted in the PSFCH symbol. The five PSFCHs may include PSFCH 4, PSFCH 5, PSFCH 3, PSFCH 1, and PSFCH 2. However, the UE may not transmit all five PSFCHs. For example, when [symbol] _{Tx,PSFCH}=4, the UE may only transmit four PSFCHs out of the five PSFCHs.

When applying a legacy priority rule, the UE may select the four PSFCHs based at least in part on a priority associated with each of the five PSFCHs. For example, PSFCH 4 may have a higher priority than PSFCH 2, PSFCH 2 may have a higher priority than PSFCH 3, PSFCH 3 may have a higher priority than PSFCH 5, and PSFCH 5 may have a higher priority than PSFCH 1 (e.g., PSFCH4=PSFCH2>PSFCH3>PSFCH5>PSFCH1). In this case, the UE may drop PSFCH 1 (which has the lowest priority among the five PSFCHs), and the UE may transmit the remaining PSFCHs (e.g., PSFCH 4, PSFCH 2, PSFCH 3, and PSFCH 5).

In some aspects, when the UE is configured to first select [symbol] , PSFCHs based at least in part on a legacy rule and then consider a PSD limit, the UE may select the PSFCHs first. For example, the UE may select the remaining PSFCHs (e.g., PSFCH 4, PSFCH 2, PSFCH 3, and PSFCH 5) to transmit. The UE may subsequently consider the PSD limit.

In some aspects, when the UE transmits PSFCH transmissions simultaneously, and multiple dedicated PRBs allocated for multiple PSFCHs are within a same 1 MHz, the UE may only transmit the PSFCH with a highest priority among PSFCHs having dedicated PRB located within the same 1 MHz. For example, the UE may drop PSFCH 5 because PSFCH 5 and PSFCH 3 are within the same 1 MHz, but PSFCH 3 has a higher priority than PSFCH 5. The UE may only transmit PSFCH 4, PSFCH 2, and PSFCH 3.

In some aspects, an upper bound for a transmitted PSFCH within the 1 MHz may be employed, and/or an actual PSFCH transmit power may be compared with the PSD limit. For example, when the upper bound for [symbol] ,1 is 2 or, [symbol] ,1, =2, the UE may only transmit PSFCH 4, PSFCH 2, PSFCH 3, and PSFCH 5. Since the upper bound is two, and PSFCH 5 and PSFCH 3 are within the same 1 MHz and correspond to the upper bound of two, the UE may transmit PSFCH 5 and PSFCH 3, along with PSFCH 4 and PSFCH 2. As another example, when the upper bound for [symbol] ,1 is 1 or [symbol] , 1, =1, the UE may transmit PSFCH 4, PSFCH 2, and PSFCH 3. Since the upper bound is one, and since PSFCH 3 has a higher priority than PSFCH 5, the UE may transmit only PSFCH 3, along with PSFCH 4 and PSFCH 2. The UE may drop PSFCH 5 based at least in part on the PSD limit.

In some aspects, when the UE is configured to first consider the PSD limit, and then select [symbol] , PSFCHs based at least in part on the legacy rule and then consider a PSD limit, the UE may consider the PSD limit first. For example, the UE may drop PSFCH 5 due to the PSD limit, because PSFCH 5 and PSFCH 3 are within the same 1 MHz, but PSFCH 3 has the higher priority than PSFCH 5. The UE may transmit PSFCH 4, PSFCH 2, and PSFCH 1 along with PSFCH 3. The UE may drop PSFCH 5 based at least in part on the PSD limit.

In some aspects, the upper bound for the transmitted PSFCH within the 1 MHz may be employed, and/or the actual PSFCH transmit power may be compared with the PSD limit. For example, when the upper bound for [symbol] , 1 is 2 or [symbol] ,1=2, the UE may only transmit PSFCH 4, PSFCH 2, PSFCH 3, and PSFCH 5. Since the upper bound is two, and PSFCH 5 and PSFCH 3 are within the same 1 MHz and correspond to the upper bound of two, the UE may transmit PSFCH 5 and PSFCH 3, along with PSFCH 4 and PSFCH 2. The UE may drop PSFCH 1 due to PSFCH 1 having the lowest priority among the five PSFCHs.

As another example, when the upper bound for [symbol] ,1 is 1 or, [symbol] ,1=1, the UE may transmit PSFCH 4, PSFCH 2, PSFCH 3, and PSFCH 1. Since the upper bound is one, and since PSFCH 3 has a higher priority than PSFCH 5, the UE may transmit only PSFCH 3, along with PSFCH 4, PSFCH 2, and PSFCH 1. The UE may drop PSFCH 5 based at least in part on the PSD limit. The UE may keep PSFCH 1 because the UE is able to transmit four PSFCHs (after considering the PSD limit).

As indicated above, FIG. 6 is provided as an example. Other examples may differ from what is described with regard to FIG. 6.

FIG. 7 is a diagram illustrating an example process 700 performed, for example, by a UE, in accordance with the present disclosure. Example process 700 is an example where the UE (e.g., UE 120) performs operations associated with power allocation for PSFCH transmissions.

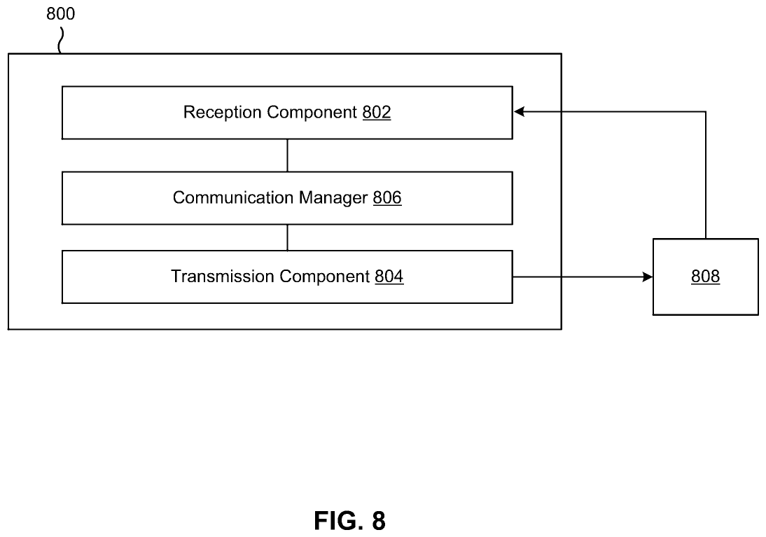

As shown in FIG. 7, in some aspects, process 700 may include identifying a plurality of PSFCH transmissions to be simultaneously transmitted within a bandwidth associated with multiple dedicated PRBs (block 710). For example, the UE (e.g., using communication manager 806, depicted in FIG. 8) may identify a plurality of PSFCH transmissions to be simultaneously transmitted within a bandwidth associated with multiple dedicated PRBs, as described above.

As further shown in FIG. 7, in some aspects, process 700 may include allocating a transmission power to a PSFCH transmission of the plurality of PSFCH transmissions based at least in part on a power allocation rule, wherein the transmission power allocated to the PSFCH transmission is associated with a defined PRB, of the multiple dedicated PRBs, within the bandwidth (block 720). For example, the UE (e.g., using communication manager 806, depicted in FIG. 8) may allocate a transmission power to a PSFCH transmission of the plurality of PSFCH transmissions based at least in part on a power allocation rule, wherein the transmission power allocated to the PSFCH transmission is associated with a defined PRB, of the multiple dedicated PRBs, within the bandwidth, as described above.

As further shown in FIG. 7, in some aspects, process 700 may include transmitting, to a second UE, the PSFCH transmission based at least in part on the transmission power (block 730). For example, the UE (e.g., using transmission component 804 and/or communication manager 806, depicted in FIG. 8) may transmit, to a second UE, the PSFCH transmission based at least in part on the transmission power, as described above.

Process 700 may include additional aspects, such as any single aspect or any combination of aspects described below and/or in connection with one or more other processes described elsewhere herein.

In a first aspect, the power allocation rule is based at least in part on a maximum UE transmitted power associated with a plurality of PSFCH transmissions assigned with a priority, a minimum power allocated from a common PRB to satisfy an OCB requirement, a quantity of common PRBs, a quantity of transmitted PSFCHs, a maximum allowed transmitted power within the bandwidth, a quantity of PRBs used by one PSFCH within the bandwidth, and a quantity of actual transmitted PSFCHs within the bandwidth.

In a second aspect, alone or in combination with the first aspect, process 700 includes prioritizing the plurality of PSFCH transmissions to be simultaneously transmitted based at least in part on a PSD limit.

In a third aspect, alone or in combination with one or more of the first and second aspects, a maximum quantity of simultaneous PSFCH transmissions are supported in a PSFCH transmission occasion, and a quantity of scheduled PSFCH transmissions are to be transmitted in the PSFCH transmission occasion, and process 700 includes selecting a quantity of PSFCHs for actual transmission, from the quantity of scheduled PSFCH transmissions, and subsequently apply a rule to satisfy the PSD limit.

In a fourth aspect, alone or in combination with one or more of the first through third aspects, the multiple dedicated PRBs are allocated for multiple PSFCHs within the bandwidth, and process 700 includes transmitting a PSFCH, of the plurality of PSFCH transmissions, associated with a highest priority among the plurality of PSFCH transmissions having the multiple dedicated PRBs located within the bandwidth, based at least in part on the rule to satisfy the PSD limit.

In a fifth aspect, alone or in combination with one or more of the first through fourth aspects, process 700 includes selecting the PSFCH, based at least in part on the PSFCH being associated with an earliest slot, among multiple PSFCHs being located within the bandwidth and having a same priority.

In a sixth aspect, alone or in combination with one or more of the first through fifth aspects, an upper bound is associated with the quantity of PSFCH transmissions, and the quantity of PSFCH transmissions is within the bandwidth, based at least in part on the rule to satisfy the PSD limit.

In a seventh aspect, alone or in combination with one or more of the first through sixth aspects, process 700 includes determining PSFCH transmissions with an ascending order of corresponding priority field values over PSFCH transmissions with HARQ-ACK information, and with an ascending order of corresponding priority field values over PSFCH transmissions with conflict information, and a quantity of actual transmitted PSFCHs within the bandwidth is based at least in part on a minimum required transmitted power per PRB for PSFCH transmission.

In an eighth aspect, alone or in combination with one or more of the first through seventh aspects, process 700 includes comparing an actual PSFCH transmit power with the PSD limit, based at least in part on the rule to satisfy the PSD limit, wherein the actual PSFCH transmit power is per one PRB per PSFCH, and a defined quantity of transmitted PSFCHs within the bandwidth is based at least in part on the actual PSFCH transmit power.

In a ninth aspect, alone or in combination with one or more of the first through eighth aspects, process 700 includes determining PSFCH transmissions with an ascending order of corresponding priority field values over PSFCH transmissions with HARQ-ACK information, and with an ascending order of corresponding priority field values over PSFCH transmissions with conflict information.

In a tenth aspect, alone or in combination with one or more of the first through ninth aspects, a maximum quantity of simultaneous PSFCH transmissions are supported in a PSFCH transmission occasion, and a quantity of scheduled PSFCH transmissions are to be transmitted in the PSFCH transmission occasion, and process 700 includes applying a rule based at least in part on the PSD limit, and subsequently selecting a quantity of PSFCHs for actual transmission, from the quantity of scheduled PSFCH transmissions.

In an eleventh aspect, alone or in combination with one or more of the first through tenth aspects, the bandwidth is associated with one MHz.

In a twelfth aspect, alone or in combination with one or more of the first through eleventh aspects, the bandwidth is associated with a common PRB and the multiple dedicated PRBs.

In a thirteenth aspect, alone or in combination with one or more of the first through twelfth aspects, the first UE and the second UE are associated with a sidelink unlicensed (SL-U).

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a first UE, or a first UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIGS. 5-6. Additionally, or alternatively, the apparatus 800 may be configured to perform one or more processes described herein, such as process 700 of FIG. 7. In some aspects, the apparatus 800 and/or one or more components shown in FIG. 8 may include one or more components of the first UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the first UE described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, a modem, a modulator, a transmit MIMO processor, a transmit processor, a controller/processor, a memory, or a combination thereof, of the first UE described in connection with FIG. 2. In some aspects, the transmission component 804 may be co-located with the reception component 802 in a transceiver.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The communication manager 806 may identify a plurality of PSFCH transmissions to be simultaneously transmitted within a bandwidth associated with multiple dedicated PRBs. The communication manager 806 may allocate a transmission power to a PSFCH transmission of the plurality of PSFCH transmissions based at least in part on a power allocation rule, wherein the transmission power allocated to the PSFCH transmission is associated with a defined PRB, of the multiple dedicated PRBs, within the bandwidth. The transmission component 804 may transmit, to a second UE, the PSFCH transmission based at least in part on the transmission power.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a first user equipment (UE), comprising: identifying a plurality of physical sidelink feedback channel (PSFCH) transmissions to be simultaneously transmitted within a bandwidth associated with multiple dedicated physical resource blocks (PRBs); allocating a transmission power to a PSFCH transmission of the plurality of PSFCH transmissions based at least in part on a power allocation rule, wherein the transmission power allocated to the PSFCH transmission is associated with a defined PRB, of the multiple dedicated PRBs, within the bandwidth; and transmitting, to a second UE, the PSFCH transmission based at least in part on the transmission power.

Aspect 2: The method of Aspect 1, wherein the power allocation rule is based at least in part on: a maximum UE transmitted power associated with a plurality of PSFCH transmissions assigned with a priority; a minimum power allocated from a common PRB to satisfy an occupied channel bandwidth (OCB) requirement; a quantity of common PRBs; a quantity of transmitted PSFCHs; a maximum allowed transmitted power within the bandwidth; a quantity of PRBs used by one PSFCH within the bandwidth; and a quantity of actual transmitted PSFCHs within the bandwidth.

Aspect 3: The method of any of Aspects 1-2, further comprising: prioritizing the plurality of PSFCH transmissions to be simultaneously transmitted based at least in part on a power spectral density (PSD) limit.

Aspect 4: The method of Aspect 3, wherein: a maximum quantity of simultaneous PSFCH transmissions are supported in a PSFCH transmission occasion, and a quantity of scheduled PSFCH transmissions are to be transmitted in the PSFCH transmission occasion, and the method further comprising: selecting a quantity of PSFCHs for actual transmission, from the quantity of scheduled PSFCH transmissions, and subsequently apply a rule to satisfy the PSD limit.

Aspect 5: The method of Aspect 4, wherein: the multiple dedicated PRBs are allocated for multiple PSFCHs within the bandwidth, and the method further comprising: transmitting a PSFCH, of the plurality of PSFCH transmissions, associated with a highest priority among the plurality of PSFCH transmissions having the multiple dedicated PRBs located within the bandwidth, based at least in part on the rule to satisfy the PSD limit.

Aspect 6: The method of Aspect 5, further comprising: selecting the PSFCH, based at least in part on the PSFCH being associated with an earliest slot, among multiple PSFCHs being located within the bandwidth and having a same priority.

Aspect 7: The method of Aspect 4, wherein an upper bound is associated with the quantity of PSFCH transmissions, and the quantity of PSFCH transmissions is within the bandwidth, based at least in part on the rule to satisfy the PSD limit.

Aspect 8: The method of Aspect 7, further comprising: determining PSFCH transmissions with an ascending order of corresponding priority field values over PSFCH transmissions with hybrid automatic repeat request acknowledgement (HARQ-ACK) information, and with an ascending order of corresponding priority field values over PSFCH transmissions with conflict information, and a quantity of actual transmitted PSFCHs within the bandwidth is based at least in part on a minimum required transmitted power per PRB for PSFCH transmission.

Aspect 9: The method of Aspect 4, further comprising: comparing an actual PSFCH transmit power with the PSD limit, based at least in part on the rule to satisfy the PSD limit, wherein the actual PSFCH transmit power is per one PRB per PSFCH, and a defined quantity of transmitted PSFCHs within the bandwidth is based at least in part on the actual PSFCH transmit power.

Aspect 10: The method of Aspect 9, further comprising: determining PSFCH transmissions with an ascending order of corresponding priority field values over PSFCH transmissions with hybrid automatic repeat request acknowledgement (HARQ-ACK) information, and with an ascending order of corresponding priority field values over PSFCH transmissions with conflict information.

Aspect 11: The method of Aspect 3, wherein: a maximum quantity of simultaneous PSFCH transmissions are supported in a PSFCH transmission occasion, and a quantity of scheduled PSFCH transmissions are to be transmitted in the PSFCH transmission occasion, and the method further comprising: applying a rule based at least in part on the PSD limit, and subsequently selecting a quantity of PSFCHs for actual transmission, from the quantity of scheduled PSFCH transmissions.

Aspect 12: The method of any of Aspects 1-11, wherein the bandwidth is associated with one megahertz (MHz).

Aspect 13: The method of any of Aspects 1-12, wherein the bandwidth is associated with a common PRB and the multiple dedicated PRBs.

Aspect 14: The method of any of Aspects 1-13, wherein the first UE and the second UE are associated with a sidelink unlicensed (SL-U).

Aspect 15: An apparatus for wireless communication at a device, comprising a processor; memory coupled with the processor; and instructions stored in the memory and executable by the processor to cause the apparatus to perform the method of one or more of Aspects 1-14.

Aspect 16: A device for wireless communication, comprising a memory and one or more processors coupled to the memory, the one or more processors configured to perform the method of one or more of Aspects 1-14.

Aspect 17: An apparatus for wireless communication, comprising at least one means for performing the method of one or more of Aspects 1-14.

Aspect 18: A non-transitory computer-readable medium storing code for wireless communication, the code comprising instructions executable by a processor to perform the method of one or more of Aspects 1-14.

Aspect 19: A non-transitory computer-readable medium storing a set of instructions for wireless communication, the set of instructions comprising one or more instructions that, when executed by one or more processors of a device, cause the device to perform the method of one or more of Aspects 1-14.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a first user equipment (UE), comprising:
one or more memories; and
one or more processors, coupled to the one or more memories, which, individually or in any combination, are operable to cause the apparatus to:
identify a plurality of physical sidelink feedback channel (PSFCH) transmissions to be simultaneously transmitted within a bandwidth associated with multiple dedicated physical resource blocks (PRBs);
allocate a transmission power to a PSFCH transmission of the plurality of PSFCH transmissions based at least in part on a power allocation rule, wherein the transmission power allocated to the PSFCH transmission is associated with a defined PRB, of the multiple dedicated PRBs, within the bandwidth; and
transmit, to a second UE, the PSFCH transmission based at least in part on the transmission power.

2. (canceled)

3. The apparatus of claim 1, wherein the one or more processors are operable to cause the apparatus to:
prioritize the plurality of PSFCH transmissions to be simultaneously transmitted based at least in part on a power spectral density (PSD) limit.

4. The apparatus of claim 3, wherein:
a maximum quantity of simultaneous PSFCH transmissions are supported in a PSFCH transmission occasion, and
a quantity of scheduled PSFCH transmissions are to be transmitted in the PSFCH transmission occasion, and
the one or more processors are operable to cause the apparatus to:
select a quantity of PSFCHs for actual transmission, from the quantity of scheduled PSFCH transmissions, and subsequently apply a rule to satisfy the PSD limit.

5. The apparatus of claim 4, wherein:
the multiple dedicated PRBs are allocated for multiple PSFCHs within the bandwidth, and
the one or more processors are operable to cause the apparatus to:
transmit a PSFCH, of the plurality of PSFCH transmissions, associated with a highest priority among the plurality of PSFCH transmissions having the multiple dedicated PRBs located within the bandwidth, based at least in part on the rule to satisfy the PSD limit.

6. The apparatus of claim 5, wherein the one or more processors are operable to cause the apparatus to:
select the PSFCH, based at least in part on the PSFCH being associated with an earliest slot, among multiple PSFCHs being located within the bandwidth and having a same priority.

7. The apparatus of claim 4, wherein an upper bound is associated with the quantity of PSFCH transmissions, and the quantity of PSFCH transmissions is within the bandwidth, based at least in part on the rule to satisfy the PSD limit.

8. The apparatus of claim 7, wherein the one or more processors are operable to cause the apparatus to:
determine PSFCH transmissions with an ascending order of corresponding priority field values over PSFCH transmissions with hybrid automatic repeat request acknowledgement (HARQ-ACK) information, and with an ascending order of corresponding priority field values over PSFCH transmissions with conflict information, and a quantity of actual transmitted PSFCHs within the bandwidth is based at least in part on a minimum required transmitted power per PRB for PSFCH transmission.

9. The apparatus of claim 4, wherein the one or more processors are operable to cause the apparatus to:
compare an actual PSFCH transmit power with the PSD limit, based at least in part on the rule to satisfy the PSD limit, wherein the actual PSFCH transmit power is per one PRB per PSFCH, and a defined quantity of transmitted PSFCHs within the bandwidth is based at least in part on the actual PSFCH transmit power.

10. The apparatus of claim 9, wherein the one or more processors are operable to cause the apparatus to:
determine PSFCH transmissions with an ascending order of corresponding priority field values over PSFCH transmissions with hybrid automatic repeat request acknowledgement (HARQ-ACK) information, and with an ascending order of corresponding priority field values over PSFCH transmissions with conflict information.

11. The apparatus of claim 3, wherein:
a maximum quantity of simultaneous PSFCH transmissions are supported in a PSFCH transmission occasion, and
a quantity of scheduled PSFCH transmissions are to be transmitted in the PSFCH transmission occasion, and
the one or more processors are operable to cause the apparatus to:
apply a rule based at least in part on the PSD limit, and subsequently selecting a quantity of PSFCHs for actual transmission, from the quantity of scheduled PSFCH transmissions.

12.-14. (canceled)

15. A method of wireless communication performed by a first user equipment (UE), comprising:
identifying a plurality of physical sidelink feedback channel (PSFCH) transmissions to be simultaneously transmitted within a bandwidth associated with multiple dedicated physical resource blocks (PRBs);
allocating a transmission power to a PSFCH transmission of the plurality of PSFCH transmissions based at least in part on a power allocation rule, wherein the transmission power allocated to the PSFCH transmission is associated with a defined PRB, of the multiple dedicated PRBs, within the bandwidth; and
transmitting, to a second UE, the PSFCH transmission based at least in part on the transmission power.

16. (canceled)

17. The method of claim 15, further comprising:
prioritizing the plurality of PSFCH transmissions to be simultaneously transmitted based at least in part on a power spectral density (PSD) limit.

18. The method of claim 17, wherein:
a maximum quantity of simultaneous PSFCH transmissions are supported in a PSFCH transmission occasion, and
a quantity of scheduled PSFCH transmissions are to be transmitted in the PSFCH transmission occasion, and
the method further comprising:
selecting a quantity of PSFCHs for actual transmission, from the quantity of scheduled PSFCH transmissions, and subsequently apply a rule to satisfy the PSD limit.

19. The method of claim 18, wherein:
the multiple dedicated PRBs are allocated for multiple PSFCHs within the bandwidth, and
the method further comprising:
transmitting a PSFCH, of the plurality of PSFCH transmissions, associated with a highest priority among the plurality of PSFCH transmissions having the multiple dedicated PRBs located within the bandwidth, based at least in part on the rule to satisfy the PSD limit.

20. The method of claim 19, further comprising:
selecting the PSFCH, based at least in part on the PSFCH being associated with an earliest slot, among multiple PSFCHs being located within the bandwidth and having a same priority.

21. The method of claim 18, wherein an upper bound is associated with the quantity of PSFCH transmissions, and the quantity of PSFCH transmissions is within the bandwidth, based at least in part on the rule to satisfy the PSD limit.

22. The method of claim 21, further comprising:
determining PSFCH transmissions with an ascending order of corresponding priority field values over PSFCH transmissions with hybrid automatic repeat request acknowledgement (HARQ-ACK) information, and with an ascending order of corresponding priority field values over PSFCH transmissions with conflict information, and a quantity of actual transmitted PSFCHs within the bandwidth is based at least in part on a minimum required transmitted power per PRB for PSFCH transmission.

23. The method of claim 18, further comprising:
comparing an actual PSFCH transmit power with the PSD limit, based at least in part on the rule to satisfy the PSD limit, wherein the actual PSFCH transmit power is per one PRB per PSFCH, and a defined quantity of transmitted PSFCHs within the bandwidth is based at least in part on the actual PSFCH transmit power.

24. The method of claim 23, further comprising:
determining PSFCH transmissions with an ascending order of corresponding priority field values over PSFCH transmissions with hybrid automatic repeat request acknowledgement (HARQ-ACK) information, and with an ascending order of corresponding priority field values over PSFCH transmissions with conflict information.

25. The method of claim 17, wherein:
a maximum quantity of simultaneous PSFCH transmissions are supported in a PSFCH transmission occasion, and
a quantity of scheduled PSFCH transmissions are to be transmitted in the PSFCH transmission occasion, and
the method further comprising:
applying a rule based at least in part on the PSD limit, and subsequently selecting a quantity of PSFCHs for actual transmission, from the quantity of scheduled PSFCH transmissions.

26.-30. (canceled)
